(19) United States
(12) Patent Application Publication
(10) Pub. No.: US 2024/0104200 A1
(43) Pub. Date: Mar. 28, 2024

(54) SYSTEMS AND METHODS FOR IDENTITY AND ACCESS RISK REDUCTION INFORMED BY RISK SIGNALING AND DEVICE POSTURE

(71) Applicant: JAMF Software, LLC, Minneapolis, MN (US)

(72) Inventor: Jesse Dresselhaus, Minneapolis, MN (US)

(21) Appl. No.: 18/472,983

(22) Filed: Sep. 22, 2023

Related U.S. Application Data
(60) Provisional application No. 63/377,034, filed on Sep. 24, 2022.

(51) Int. Cl. G06F 21/55

(52) U.S. Cl. CPC G06F 21/552

(57) ABSTRACT

A system and method identifies an elevated risk factor of an endpoint device on a computing network according to one or more characteristics of the endpoint device. A user associated with the endpoint device having the elevated risk factor is determined. User credentials associated with the user on one or more computing systems and/or computing applications accessible on the computing network are disabled based on the elevated risk factor. The endpoint device having the elevated risk factor is included in a group of endpoint devices identified as having an elevated risk level. Access by the group of endpoint devices identified as having the elevated risk level is restricted to one or more computing systems and/or computing applications accessible on the computing network based on the elevated risk level.

### CROSS-REFERENCE TO RELATED APPLICATIONS

The present application claims the benefit of priority under 35 U.S.C. § 119 from U.S. Provisional Patent Application Ser. No. 63/377,034 entitled “Systems and Methods for Identity and Access Risk Reduction Informed by Risk Signaling and Device Posture,” filed on Sep. 24, 2022, the disclosure of which is hereby incorporated by reference in its entirety for all purposes.

### TECHNICAL FIELD

The present disclosure generally relates to computer system security, and more specifically relates to dynamic reduction of computing system attack surface responsive to positive threat detection.

### BACKGROUND

Mobile devices are becoming increasingly prevalent in everyday use, including in home, office, and educational environments. For example, school districts are starting to implement one-to-one technology programs that provide each student access to a mobile device, such as a tablet computer. As another example, many corporations provide employees with mobile devices to perform job-related functions on-the-go. Mobile devices provided by an organization to users of its computing networks and systems may be more vulnerable to various security risks and attacks than fixed-location devices within the organization, such as desktop computers, and may be subjected to various risks and threats that fixed-location devices may not be.

### BRIEF DESCRIPTION OF DRAWINGS

The disclosure is better understood with reference to the following drawings and description. The elements in the figures are not necessarily to scale, emphasis instead being placed upon illustrating the principles of the disclosure. Moreover, in the figures, like-referenced numerals may designate to corresponding parts throughout the different views.

FIG. 1 is a diagram that illustrates a particular embodiment of a system that is operable to maintain dynamically updated groups of managed devices;

FIG. 2 is a diagram that illustrates inventory data of the system of FIG. 1;

FIG. 3 illustrates a particular embodiment of a method of dynamically updating group membership;

FIG. 4 illustrates a particular embodiment of a dynamic grouping graphical user interface (GUI);

FIG. 5 illustrates another particular embodiment of a dynamic grouping GUI;

FIG. 6 illustrates another particular embodiment of a dynamic grouping GUI;

FIG. 7 illustrates another particular embodiment of a dynamic grouping GUI;

FIG. 8 illustrates another particular embodiment of a dynamic grouping GUI;

FIG. 9 illustrates another particular embodiment of a dynamic grouping GUI;

FIG. 10 illustrates another particular embodiment of a dynamic grouping GUI;

FIG. 11 illustrates another particular embodiment of a dynamic grouping GUI; and

FIG. 12 is a flowchart to illustrate a particular embodiment of a method of operation at a mobile device management (MDM) server.

FIG. 13 is a flowchart to illustrate a particular embodiment of a method of operation at a MDM server and a managed computer.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### SUMMARY

The present disclosure provides systems and methods that enable a mobile device management (MDM) server to provide a fast, dynamic reduction of attack surface and reduce risks of lateral movement across systems in the protected computing environment by disabling credentials of a user whose devices (e.g., cell phones, tablets, laptop computers) have potentially been compromised by an attack and are more likely subject to credential theft, as well as disabling access by the user's devices themselves to critical business systems. The MDM server may provide these capabilities via “smart” groups for which the MDM server may maintain and update inventory information. As used herein, a “smart” group may be a group of devices whose membership is dynamically updated in response to certain events. To illustrate, an IT administrator may create a group that has particular membership/grouping criteria. The membership of the group may be dynamically updated as managed devices (e.g., mobile phones, tablet computers, laptop computers, etc.) check-in with the MDM server and provide updated inventory information. An IT administrator may use the dynamically updated group to more easily and quickly perform MDM actions. As an illustrative non-limiting example, a dynamically updated group may be created for devices that have not backed up data to the MDM server (or another external backup device) in the last 30 days. To send a reminder message regarding backup to all devices that have not backed up in the last 30 days, an IT administrator may select the group as a recipient of the message, which may be faster and easier than the IT administrator identifying each individual device that has not backed up in the past 30 days. For example, using dynamic groups of managed devices to select targets of MDM actions may be faster than the IT administrator querying a device database or requesting individual device users to indicate when their respective devices were backed up.

In an example, an elevated risk factor of an endpoint device on a computing network is identified according to one or more characteristics of the endpoint device. A user associated with the endpoint device having the elevated risk factor is determined. User credentials associated with the user on one or more computing systems and/or computing applications accessible on the computing network are disabled based on the elevated risk factor.

In an example, an elevated risk factor of an endpoint device on a computing network is identified according to one or more characteristics of the endpoint device. The endpoint device having the elevated risk factor is included in a group of endpoint devices identified as having an elevated risk level. Access by the group of endpoint devices identified as having the elevated risk level is restricted to one or more computing systems and/or computing applications accessible on the computing network based on the elevated risk level. The one or more characteristics of the endpoint device may include a version of an installed operating system being out of date. The one or more characteristics of the endpoint device may include a geolocation of the endpoint device. A user associated with the endpoint device having the elevated risk factor may be identified. One or more additional endpoint devices on the computing network associated with the identified user may be identified. The one or more additional endpoint devices may be included in the group of endpoint devices identified as having the elevated risk level. User credentials associated with the user may be disabled on one or more computing systems and/or computing applications accessible on the computing network based on the elevated risk factor.

In an example, a non-transitory computer-readable storage device storing instructions that, when executed by a processor, cause the processor to perform operations is provided. The instructions that, when executed by a processor, cause the processor to identify an elevated risk factor of an endpoint device on a computing network according to one or more characteristics of the endpoint device. The instructions that, when executed by a processor, cause the processor to include the endpoint device having the elevated risk factor in a group of endpoint devices identified as having an elevated risk level. The instructions that, when executed by a processor, cause the processor to restrict access by the group of endpoint devices identified as having the elevated risk level to one or more computing systems and/or computing applications accessible on the computing network based on the elevated risk level. In certain aspects, instructions that, when executed by a processor, cause the processor to identify a user associated with the endpoint device having the elevated risk factor. In certain aspects, instructions that, when executed by a processor, cause the processor to identify one or more additional endpoint devices on the computing network associated with the identified user. In certain aspects, instructions that, when executed by a processor, cause the processor to include the one or more additional endpoint devices in the group of endpoint devices identified as having the elevated risk level. In certain aspects, instructions that, when executed by a processor, cause the processor to disable user credentials associated with the user on one or more computing systems and/or computing applications accessible on the computing network based on the elevated risk factor.

It should be noted that although various embodiments may be described herein with reference to educational or corporate settings, this is an example only and not to be considered limiting. The teachings of the present disclosure may be applied to other mobile device environments, including but not limited to home environments, retail environments, etc.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The average dwell time of cybersecurity threats within an organization's computing network is reducing over time. Thus, there is a need for network security teams to react faster in order to mitigate potential damage from such threats and prevent bad actors' access to core systems within the organization's computing network. Phishing scams are also one of the most common ways hackers may gain unauthorized access to an organization's computing systems. With more than 80 percent of security breaches within hacking involving brute force or using lost or stolen credentials, the risk of providing required user connectivity to critical business systems via mobile devices is growing.

Therefore, there is a need for an organization's computing network security teams to implement faster and more dynamic responses to security threat detection in an effort to mitigate risk and potential damage. Herein are described novel systems and methods to provide fast, dynamic reduction of attack surface and to reduce the risk of lateral movement by disabling the credentials of a user whose portable devices have potentially been compromised (and more likely subject to credential theft), and disabling the potentially compromised user's devices' access to critical business systems. The systems and methods described herein may utilize and be built upon a mobile device management system that dynamically updates groups of devices as well as inventories of features and characteristics thereof.

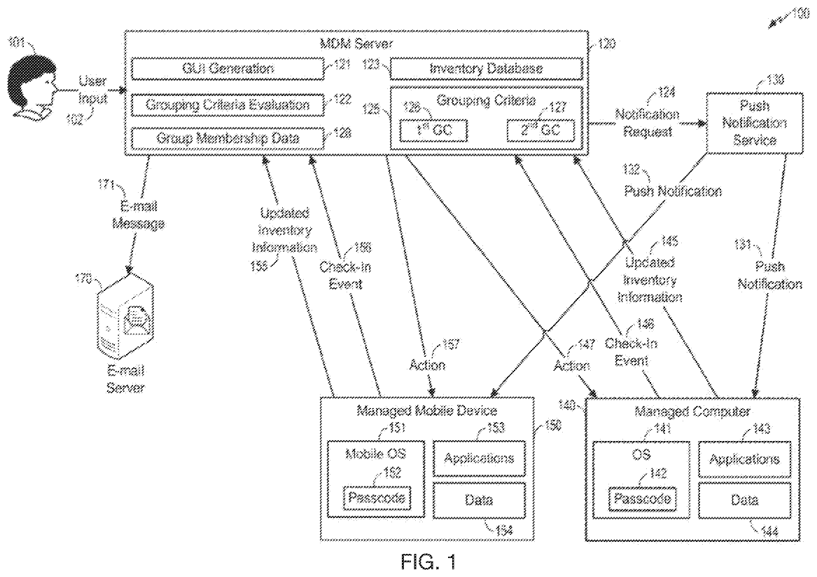

Referring to FIG. 1, a particular embodiment of a system that is operable to maintain dynamically updated groups of devices is shown and generally designated 100. The system includes a mobile device management (MDM) server 120 that is communicably coupled to a push notification service 130, one or more managed computers (e.g., an illustrative managed computer 140), one or more managed mobile devices (e.g., an illustrative managed mobile device 150), and an e-mail server 170. It should be noted that although one managed computer 140 and one managed mobile device 150 is shown in FIG. 1, the present disclosure is not limited to any particular configuration or number of devices. In alternate embodiments, a different number of managed computers and/or managed mobile devices may be present. For example, more than one managed computer and more than one managed mobile device may be registered with the MDM server 120.

The managed computer 140 may be a portable computing device with wired and/or wireless networking capability. For example, the managed computer 140 may be a desktop computer, a laptop computer, a server, etc. The managed mobile device 150 may be a portable device with wireless networking capability. For example, the managed mobile device 150 may be a tablet computer, a mobile phone, a portable media player, an electronic book (eBook) reader, or any combination thereof.

The managed computer 140 may include an operating system (OS) 141 and the managed mobile device 150 may include a mobile OS 151. Each OS 141, 151 may control computing functions, such as input/output (e.g., a touchscreen display, speaker, microphone, camera, etc.) and networking (e.g., cellular, Bluetooth, Wi-Fi, Ethernet, etc.). Each OS 141, 151 may also support execution of applications (apps) 143, 153 and provide such applications access to device resources and data 144, 154. Examples of applications include, but are not limited to, a web browser, e-mail, a calendar, social networking, a document/eBook reader, a media player, etc. Applications may correspond to software instructions that are stored in a memory and executed by a processor, hardware circuits that implement application functionality, or both. The applications 143, 153 may be pre-installed (e.g., as part of or along with an OS) or may be installed after being downloaded (e.g., via a storefront) or sideloaded (e.g., from an external storage device). In a particular embodiment, each OS 141, 151 stores a passcode 142, 152. For example, the passcodes 142, 152 may be used to secure device access. When a user attempts to operate a device, the user may be prompted to input a passcode, and access to the device may not be enabled unless the input passcode matches the stored passcode 142, 152.

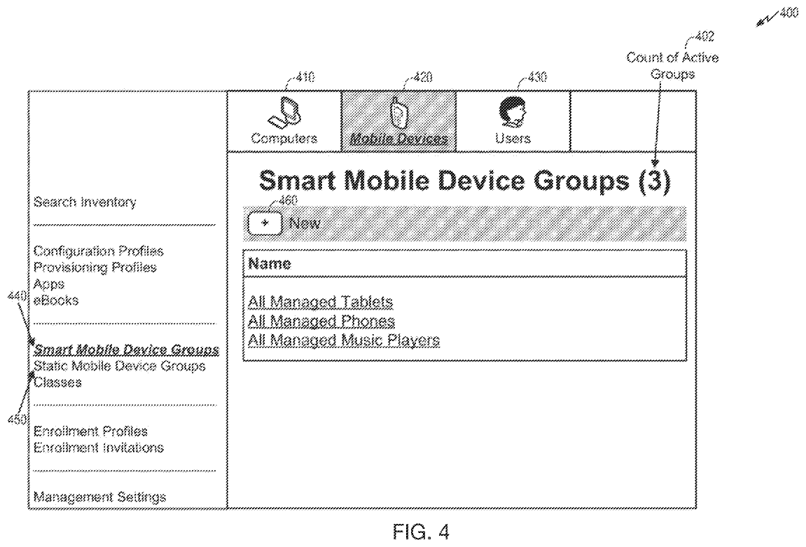

The MDM server 120 may correspond to hardware and/or software that implements MDM functions. As an illustrative non-limiting example, in an educational context, the MDM server 120 may manage teacher and student computers and mobile devices. The MDM server 120 may include a graphical user interface (GUI) generation module 121. The GUI generation module 121 may generate a GUI that is operable to (e.g., that can be used to) define dynamic groups. For example, the MDM server 120 may send the generated GUI to a computing device associated with a user 101 (e.g., an IT administrator) and may receive user input 102 via the GUI. The user input 102 may define grouping criteria for one or more dynamic groups, as further described herein. The MDM server 120 may store grouping criteria 125 received via the GUI. Examples of the GUI generated by the GUI generation module 121 are further described with reference to FIGS. 4-11.

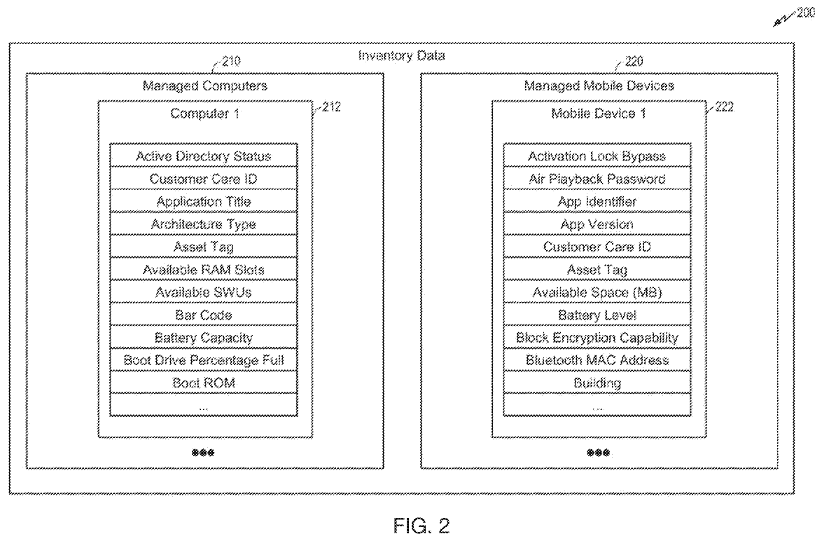

The MDM server 120 may include a grouping criteria evaluation module 122 and may store (or have access to) an inventory database 123 and group membership data 128, as shown. The inventory database 123 may include data regarding each managed entity (e.g., a computer or a mobile device) in the system 100. An example of the data stored in the inventory database 123 is further described with reference to FIG. 2. In a particular embodiment, the inventory database 123 includes values of various inventory attributes for each managed entity. As an illustrative non-limiting example, inventory data for a managed computer may include values for one or more of the following inventory attributes:

Active Directory Status, Application Title, Application Version, Architecture Type, Asset Tag, Available RAM Slots, Available SWUs, Bar Code, Battery Capacity, Boot Drive Percentage Full, Boot ROM, Building, Bus Speed MHz, Cached Packages, Computer Group, Computer Name, Department, Disk Encryption Configuration, Drive Capacity MB, Customer Care ID, Encrypted Volumes Eligibility, Encrypted Volumes Individual Key Validation, Encrypted Volumes Institutional Key, Encrypted Volumes Partition Encryption State, Encrypted Volumes Recovery Key Type, Encrypted Volumes Status, Encrypted Volumes User, Email Address, Enrollment Method: PreStage enrollment, Font Title, Font Version, Full Name, IP Address, Last Check-in, Last Enrollment, Last Inventory Update, Lease Expiration, Licensed Software, Life Expectancy, Local User Accounts, MAC Address, Make, Mapped Printers, Master Password Set, MDM Platform Binary Version, MDM Server ID, Model, Model Identifier, NIC Speed, Number of Available Updates, Number of Processors, Operating System, Optical Drive, Packages Installed By MDM Suite, Packages Installed By Native Installer/SWU, Partition Name, Phone Number, Platform, Plug-in Title, Plug-in Version, PO Date, PO Number, Position, Processor Speed MHz, Processor Type, Purchase Price, Purchased or Leased, Purchasing Account, Purchasing Contact, Room, Running Services, S.M.A.R.T. Status, Scheduled Tasks, Serial Number, Service Pack, SMC Version, Total RAM MB, Username, Vendor, Warranty Expiration

As another illustrative non-limiting example, inventory data for a managed mobile device may include values for one or more of the following inventory attributes:

Activation Lock Bypass Enabled, App Identifier, App Name, App Version, Asset Tag, Available Space MB, Battery Level, Block Encryption Capability, Bluetooth MAC Address, Building, Capacity MB, Carrier Settings Version, Cellular Technology, Certificate Name, Current Carrier Network, Current Mobile Country Code, Current Mobile Network Code, Customer Care ID, Data Protection, Data Roaming Enabled, Department, Device ID, Device Locator Service Enabled, Device Phone Number, Display Name, Do Not Disturb Enabled, Email Address, Enrollment Method: Enrollment profile, Enrollment Method: PreStage enrollment, Enrollment Method: User-initiated—invitation, Enrollment Method: User-initiated—no invitation, Expires, File Encryption Capability, Full Name, Hardware Encryption, Home Carrier Network, Home Mobile Country Code, Home Mobile Network Code, ICCID, Identifier, Identity, IMEI, IP Address, Languages, Last Backup, Last Enrollment, Last Inventory Update, Lease Expiration, Life Expectancy, Locales, MDM Profile Removal Allowed, MEID, Mobile Device Group, Model, Model Identifier, Modem Firmware Version, OS Build, OS Version, Passcode Compliance, Passcode Compliance with Profile(s), Passcode Status, PO Date, PO Number, Position, Profile Name, Provisioning Profile Name, Purchase Price, Purchased or Leased, Purchasing Account, Purchasing Contact, Roaming, Room, Serial Number, Subscriber MCC, Subscriber MNC, Supervised, UDID, Used Space Percentage, User Phone Number, Username, Vendor, Version, Voice Roaming Enabled, Warranty Expiration, Wi-Fi MAC Address, Wireless Media Streaming Password

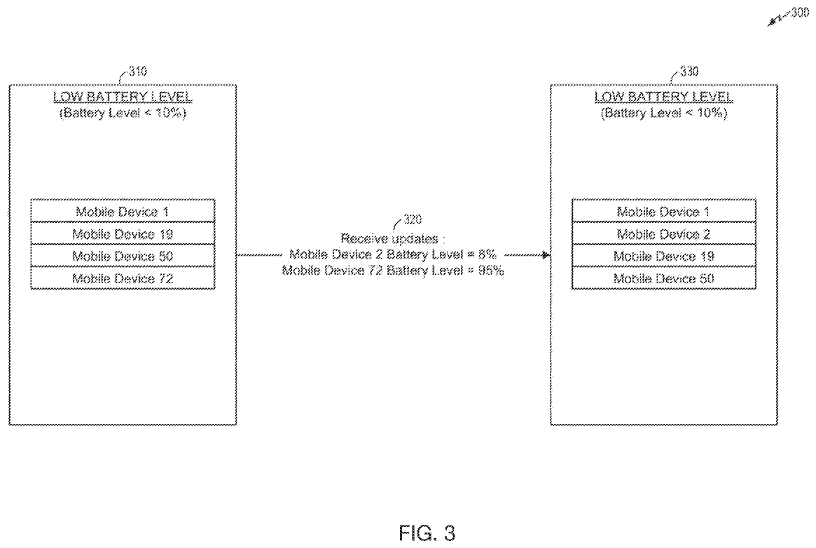

The group membership data 128 may include a list of devices that are members of each dynamic group maintained by the MDM server 120. The group membership data 128 may be updated in response to various events that occur in the system 100. As illustrative non-limiting examples, the group membership data 128 may be updated responsive to a managed device being added to the system 100, a managed device being removed from the system 100, a managed device providing updating inventory data to the MDM server 120, etc. An example of updating the group membership data 128 is further described with reference to FIG. 3. In a particular embodiment, the MDM server 120 transmits an alert in response to a change in membership of a group. For example, the MDM server 120 may send an e-mail message 171 to the user 101 or to another IT administrator via the e-mail server 170. Additional examples of alerts may include, but are not limited to, short message service (SMS) messages, instant messages, GUI alerts, automated telephone calls, etc.

In a particular embodiment, the user input 102 may include data identifying an action to be performed with respect to managed entities (e.g., managed devices) of a particular dynamic group. For example, a “Low Battery Laptops” dynamic group may include laptops that have battery levels less than a threshold (“Battery Level<10%”), and the action may be displaying a pop-up message on the laptops to remind users to charge the laptops.

Examples of MDM actions may include, but are not limited to, installing an application at a managed device, adjusting a configuration setting at a managed device, providing content to a managed device, sending a message to a managed device, setting or clearing a passcode, editing one or more inventory data attributes, sending a communication/message (e.g., an e-mail or a SMS message), deleting data, sending remote commands, etc.

In response to receiving the user input 102, the grouping criteria evaluation module 122 may determine, based on the membership data 128 and/or the inventory database 123, which laptops are members of the “Low Battery Laptops” group and may initiate transmission of a push notification to such laptops. As further described herein, the MDM server 120 may have previously received and stored information regarding the battery level of the laptops, based on inventory data updates provided by the laptops. Alternatively, or in addition, the MDM server 120 may request battery level information responsive to receiving the user input 102. In a particular embodiment, the MDM server 120 may send a notification request 124 to a push notification service 130, where the notification request 124 identifies the laptops.

In an illustrative embodiment, the GUI enables the user 101 to define dynamic groups via recursive application of grouping criteria. For example, the user input 102 may define a first dynamic group based on first grouping criteria 126 and a second dynamic group based on second grouping criteria 127. The first grouping criteria 126 may be based on at least the second grouping criteria 127 and a logical operator.

To illustrate, the second dynamic group may be called “Science Department Mobile Devices” and may include mobile devices that are the property of (or assigned to) a science department at a school. Accordingly, the second grouping criteria 127 may include a value “Science” of an inventory attribute “Department,” e.g., the second grouping criteria 127 may be “Department=Science.” The first dynamic group may be called “Chemistry Building Mobile Devices” and may include science department mobile devices that are located in the chemistry building of the school. Accordingly, the first grouping criteria 126 may be:

“Mobile Device Group=Science Department Devices AND Building=Chemistry”

Thus, the first dynamic grouping criteria 126 (e.g., chemistry building mobile devices) may be based on at least the second dynamic grouping criteria 127 (e.g., science department mobile devices) and a logical operator (e.g., an AND operator). Examples of logical operators that can be used in grouping criteria include, but are not limited to: and, or, not, is, is not, has, does not have, member of, not member of, organizational operators (e.g., open parenthesis, close parenthesis, etc.), and mathematical operators (e.g., equal to, not equal to, greater than, less than, etc.).

It should be noted that although various embodiments are described herein with reference to educational settings, this is for example only and not to be considered limiting. The teachings of the present disclosure may be applied to other environments, including but not limited to home environments, corporate environments, retail environments, etc.

During operation, the MDM server 120 may receive the user input 102, where the user input 102 includes dynamic grouping criteria and/or identifies action(s) to be performed with respect to the devices of a particular dynamic group. In an illustrative embodiment, the user 101 may be prompted for authentication credentials (e.g., a username, a password, a uniform resource locator (URL) of the MDM server 120, etc.) prior to being granted access to the GUI. Communication between the various components of the system 100 may occur via secure (e.g., encrypted) channels, such as encrypted internet protocol (IP) connections.

When the user input 102 indicates that an action is to be performed with respect to devices of a group, the grouping criteria evaluation module 122 may determine which devices are members of the group. The MDM server 120 may send a notification request 124 to the push notification service 130, where the push notification request 124 identifies the devices that are determined to be members of the group. The push notification service 130 may correspond to one or more network accessible servers that are configured to send push notifications 131, 132 to devices of the group, such as the managed computer 140 and/or the managed mobile device 150.

In a particular embodiment, the push notifications 131, 132 may be associated with check-in events 146 and 156 that cause the managed computer 140 and the managed mobile device 150 to check with the MDM server 120 to see if there are any actions to be performed by the managed computer 140 or the managed mobile device 150. For example, actions 147, 157 specified by the user input 102 may be “queued” by the MDM server 120 and may be retrieved by the managed computer 140 and the managed mobile device 150 in response to the push notifications 131, 132.

In an alternate embodiment, the push notifications 131, 132 may include or identify the action to be performed. For example, the push notifications 131, 132 may utilize an application programming interface (API) of the OS 141 or 151 to instruct the managed computer 140 or the managed mobile device 150 to perform the action. In yet another alternate embodiment, a notification and/or an action may be pushed by the MDM server 120 directly to the managed computer 140 or to the managed mobile device 150. For example, when the managed mobile device 150 is an iOS® device, the command may be compatible with an iOS® MDM API/protocol, such as a device lock command, a clear passcode command, etc. (iOS is a registered trademark of Cisco Systems, Inc. of San Jose, Calif and is used by Apple Inc. of Cupertino, Calif under license).

During operation, the managed computer 140 and the managed mobile device 150 may provide updated inventory information 145, 155 to the MDM server 120. The updated inventory information 145, 155 may indicate change(s) in inventory attribute(s) associated with the managed computer 140 and the managed mobile device 150. A managed device may provide updated inventory information to the MDM server 120 in response to a particular event (e.g., performance of a MDM action, relocation into a different building, power-on, wake from sleep mode, etc.). Alternatively, or in addition, updated inventory information may be provided periodically or in response to user input or in response to a request from the MDM server 120. In a particular embodiment, to reduce an amount of data transmitted to the MDM server 120, the updated inventory information only identifies changed values of inventory attributes, instead of values of all inventory attributes. In response to receiving the updated inventory information 145 or 155, the MDM server may update a record in the inventory database 123 for the corresponding managed computer 140 or managed mobile device 150. When the updated inventory information 145, 155 results in addition of the managed computer 140 or the managed mobile device 150 to a dynamic group, or removal from a dynamic group, the MDM server 120 updates the group membership data 128. To illustrate, the MDM server 120 may receive an update from a device, where the update indicates that the device has moved to the chemistry building at the school. The MDM server 120 may update a record in the inventory database 123 for the device to reflect that the device has moved to the chemistry building. The MDM server 120 may also update the group membership data 128 (which may include group membership lists) by adding the device to group(s) whose grouping criteria 125 include “Building=Chemistry” and removing the device from group(s) whose grouping criteria 125 include a different value for “Building.”

The system 100 of FIG. 1 may thus support creation and updating of dynamic groups and transmission of push notifications to devices that are in a particular dynamic group. Using dynamic (e.g., “smart”) groups to perform MDM actions is typically faster than a user selecting devices one-at-a-time. It will also be appreciated that the system 100 may update group membership automatically based on inventory updates from managed devices and may evaluate group membership just-in-time (e.g., in response to a MDM action request), so that appropriate managed devices are targeted for the MDM action (as opposed to targeting devices based on “stale” inventory information).

Referring to FIG. 2, a particular embodiment of inventory data is shown and generally designated 200. In an illustrative embodiment, the inventory data 200 may be stored in an inventory database, such as the inventory database 123 of FIG. 1.

The inventory data 200 may include managed computer inventory data 210 and managed mobile device inventory data 220. The managed computer inventory data 210 may include inventory data associated with one or more managed computers that are registered with a MDM server (e.g., the MDM server 120 of FIG. 1). In the illustrated example, the managed computer inventory data 210 includes data 212 associated with a first managed computer (Computer 1). The data 212 associated with the first managed computer may include values of one or more inventory attributes, which may include but are not limited to active directory status, customer care ID, application title, bar code, battery capacity, etc. Additional inventory attributes associated with managed computers are described with reference to FIG. 1.

The managed mobile device inventory data 220 may include inventory data associated with one or more managed mobile devices that are registered with a MDM server (e.g., the MDM server 120 of FIG. 1). In the illustrated example, the managed mobile device inventory data 220 includes data 222 associated with a first managed mobile device (Mobile Device 1). The data 222 associated with the first managed mobile device may include values of one or more inventory attributes, which may include, but are not limited to, activation lock bypass, air playback password, customer care ID, asset tag, battery level, etc. Additional inventory attributes associated with managed mobile devices are described with reference to FIG. 1.

Referring to FIG. 3, an illustrative embodiment of dynamically updating group membership is shown and generally designated 300. In the example of FIG. 3, group membership for a “Low Battery Level” group is shown. The grouping criteria for the group is “Battery Level<10%.” Thus, mobile devices with battery levels below 10% will be members of the group.

In the example of FIG. 3, mobile device 1, mobile device 19, mobile device 50, and mobile device 72 are initially members of the low battery level group, as shown at 310. Thus, the group membership data 128 of FIG. 1 for the low battery level group may identify mobile device 1, mobile device 19, mobile device 50, and mobile device 72. Inventory data in the inventory database 123 of FIG. 1 may store a most recently known (e.g., received) battery level for the mobile devices.

A MDM server (e.g., the MDM server 120 of FIG. 1) may receive updates from mobile devices during operation. For example, as shown at 320, the MDM server may receive a first update that a battery level of mobile device 2 is 8% and a second update that a battery level of mobile device 72 is 95%.

In response to receiving the updates, the MDM server may store the received battery level information in the inventory database. The MDM server may also dynamically update group membership data for one or more groups that include battery level as a grouping criterion. For example, as shown at 330, mobile device 2 is added to the low battery level group and mobile device 72 is removed from the low battery level group. In a particular embodiment, instead of modifying group membership data in response to each update from each managed device (e.g., in real-time or near-real-time), the MDM server may queue updates and may process updates asynchronously (e.g., when the MDM server has available resources to process the queued updates). In such an embodiment, if a MDM action is requested by a user, the update queue may be processed (e.g., “emptied”) before group membership data is evaluated to identify devices to be notified regarding the MDM action.

It should be noted that the examples shown in FIG. 3 are for illustration only and not to be considered limiting. At any given time, a managed device may be a member of any number of dynamic groups. A device may be removed from a group, added to a group, or both removed from one group and added to another group in response to an update. For example, in response to the update that the battery level of the mobile device 72 is 95%, the mobile device 72 may be removed from the low battery level group and added to a “high battery level” group having grouping criteria “Battery Level>90%.” Thus, as illustrated in FIG. 3, a MDM server may dynamically update group membership data based on updated information received from managed devices. It should be noted that although FIG. 3 illustrates updating group membership data based on a change in a single attribute, device updates may include updated values for multiple attributes and group membership data may be updated in response to changes in multiple attributes.

In a particular embodiment, a MDM server (e.g., the MDM server 120) may maintain static groups as well as dynamic groups. Static groups may have fixed membership that is not dynamically updated. For example, a static group having the grouping criteria “Manufacturer=Company X” may have a fixed membership including managed devices manufactured by company X.

Although various embodiments have been described herein with reference to managed computers and managed mobile devices, dynamic groups of other types of managed entities may also be created and used. For example, the MDM server 120 may support creating and using dynamic groups of users. Each user may be associated with one or more managed devices (e.g., computers or mobile devices), and sending a push notification to a user may result in sending a push notification to one or more managed devices associated with a user. Grouping criteria for dynamic user groups may include values for inventory attributes, such as one or more of the following:
Content Name, Content Type, Email Address, Full Name, Phone Number, Position, Username, Volume Purchase Program (VPP) Account, VPP Invitation Status.

FIGS. 4-11 illustrate particular embodiments of a graphical user interface (GUI) that may be generated by the GUI generation module 121 of FIG. 1. The MDM server 120 may provide the GUI to a display device for display. For example, the GUI may be displayed at a display device visible to the user 101. The user 101 may use an input device, such as a keyboard, a mouse, a touchscreen, etc. to provide the user input 102 responsive to the GUI.

Referring to FIG. 4, a first embodiment of a GUI is shown and generally designated 400. The GUI 400 includes elements (e.g., icons, links, buttons, etc.) 410, 420, and 430 to select managed computer options, managed mobile device options, and managed user options, respectively. In the illustrated example, the element 420 for mobile devices is selected. The GUI 400 also includes elements 440 and 450 that are selectable to display a list of “smart” (e.g., dynamic) mobile device groups and a list of static mobile device groups, respectively. In the illustrated example, the element 440 for smart mobile device groups is selected.

As shown in FIG. 4, the GUI 400 may include a count 402 of a number of active groups. In the illustrated example, three dynamic groups are active: “All Managed Tablets,” “All Managed Phones,” and “All Managed Music Players.” A user may select (e.g., click on, tap on, etc.) a link for an active managed group or a button 460 to define a new dynamic mobile device group. Selecting an active managed group may enable the user to modify grouping criteria and/or other settings associated with the selected group. Selecting the “new” button 460 may enable the user to define grouping criteria for a newly added dynamic group.

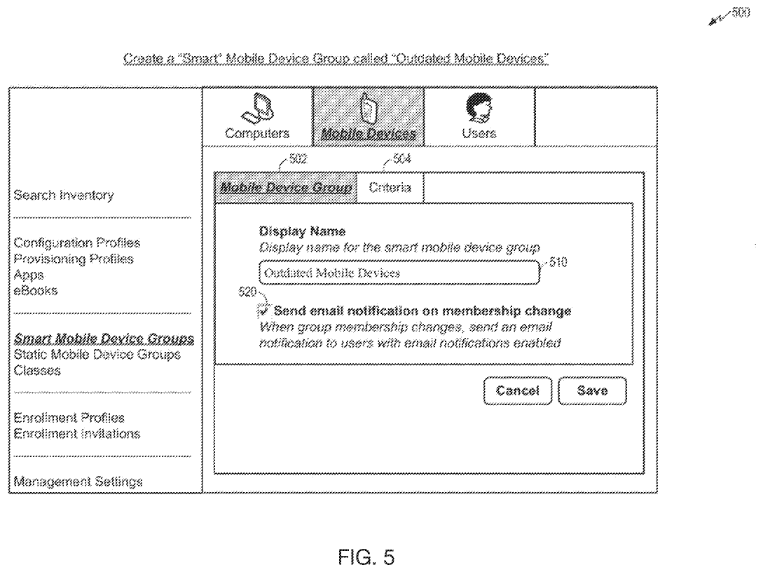

For example, FIG. 5 illustrates a particular embodiment of a GUI 500 corresponding to selection of the “new” button 460 of FIG. 4. The GUI 500 includes a “Mobile Device Group” tab 502 and a “Criteria” tab 504. In the example of FIG. 5, the “Mobile Device Group” tab is selected. The user is creating a new dynamic group for mobile devices, and, as shown at 510, has entered the name “Outdated Mobile Devices” for the group. The user has also selected an option 520 to cause a MDM server (e.g., the MDM server 120 of FIG. 1) to initiate sending an e-mail notification to the user (e.g., to a device associated with the user) when membership of the “Outdated Mobile Devices” group changes. To illustrate, the e-mail notification may correspond to the e-mail message 171 of FIG. 1.

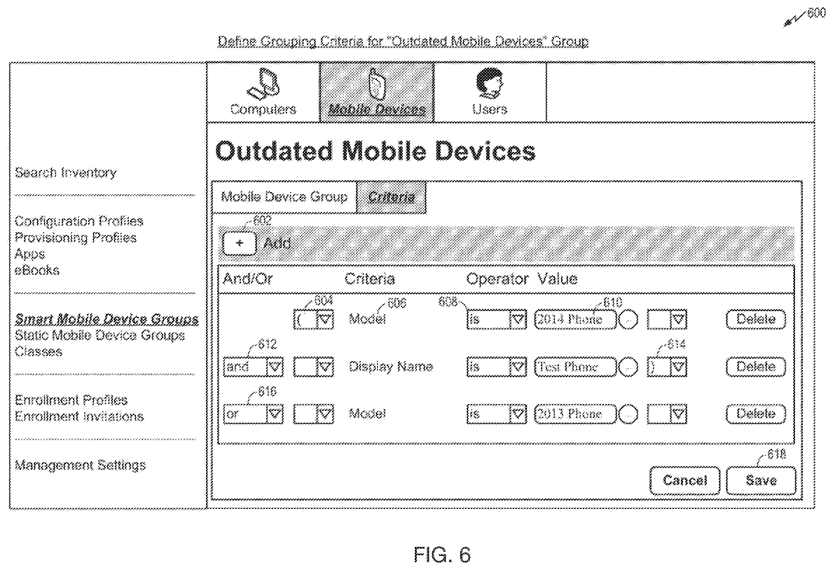

Continuing to FIG. 6, a particular embodiment of a GUI corresponding to selection of the “Criteria” tab 504 of FIG. 5 is shown and is generally designated 600. The GUI 600 may include various elements. In the example of FIG. 6, a button 602 may be used to add another criterion to the grouping criteria. An element 604 is used to include an open parenthesis operator in the grouping criteria. At 606, an inventory data attribute “Model” (e.g., mobile device model) is selected for inclusion in the criteria. As shown at 608 and 610, the sub-criteria involving the “Model” attribute includes an IS operator and the value “2014 Phone.” Thus, the “Model” sub-criteria may be satisfied by managed mobile devices having a value of “2014 Phone” for the “Model” inventory attribute. At 612, an AND operator is selected to combine the “Model is 2014 Phone” sub-criteria with a “Display Name is Test Phone” sub-criteria. A close parenthesis operator is selected, at 614, and an OR operator is selected, at 616, to combine the sub-criteria within the parentheses to a sub-criteria “Model is 2013 Phone.” Thus, an overall grouping criteria defined in the GUI of FIG. 6 is:

(Model is 2014 Phone and Display Name is Test Phone) or Model is 2013 Phone.

Accordingly, mobile devices that are members of the “Outdated Mobile Devices” group will be 2014 model “test” (e.g., beta) phones or 2013 model phones. The user may select a button 618 to save the grouping criteria and finish defining the “Outdated Mobile Devices” group. When the “Outdated Mobile Devices” group is saved, the count 402 of active groups may increase from 3 to 4, and a link for “Outdated Mobile Devices” may be displayed along with the previously displayed links for “All Managed Tablets,” “All Managed Phones,” and “All Managed Music Players.”

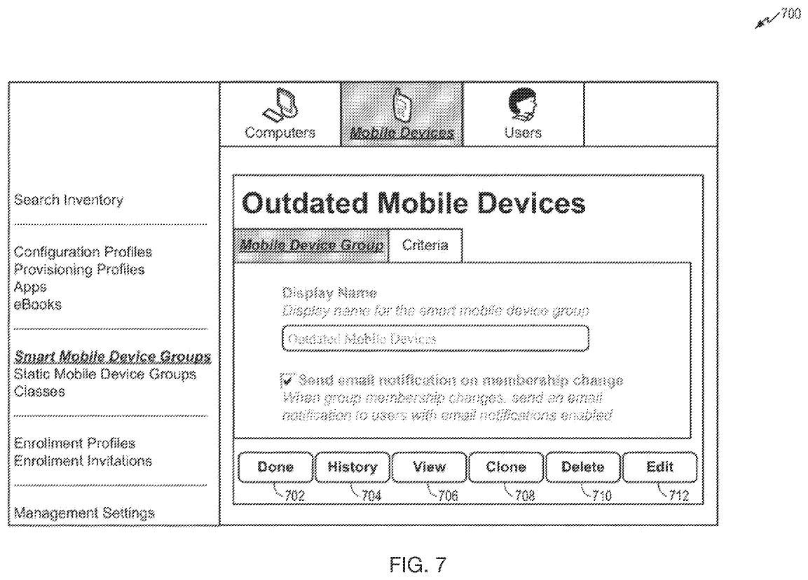

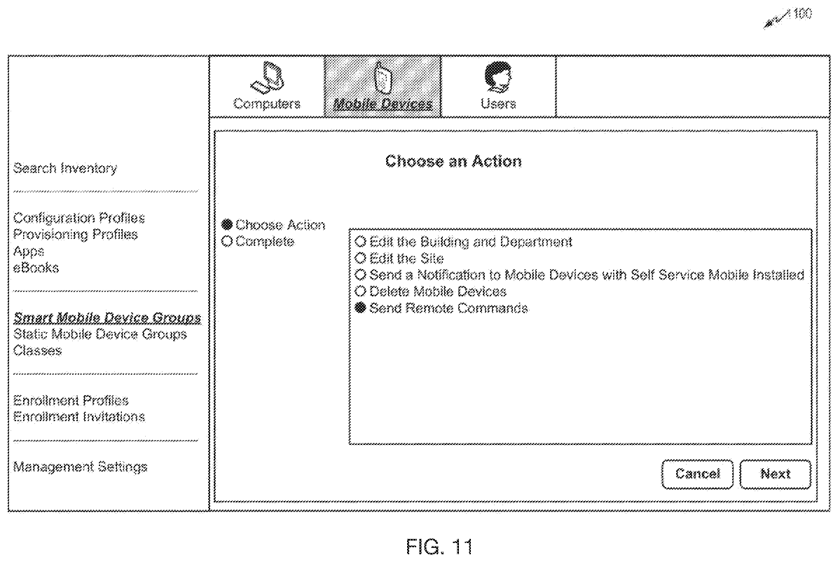

Referring to FIG. 7, a particular embodiment of a GUI displayed responsive to selection of a previously created dynamic group is shown and generally designated 700. In particular, the GUI 700 corresponds to a user selecting the link for the previously created “Outdated Mobile Devices” group. The GUI 700 includes a “Done” button 702 to save changes to the group, a “History” button 704 to view history information associated with the group (e.g., how the grouping criteria of the group has evolved over time) and a “View” button 706 to view members of the group. After selecting the view button 706, a user may select an action to be performed with respect to members of the group, as further described with reference to FIG. 11.

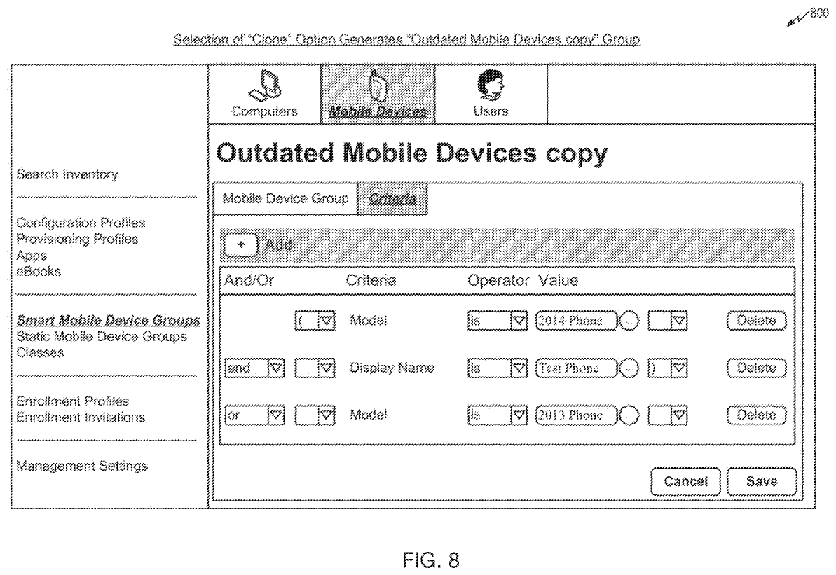

The GUI 700 also includes a “Clone” button 708 to create a copy of the group. For example, as shown in the GUI 800 of FIG. 8, selection of the clone button 708 may result in creation of an “Outdated Mobile Devices copy” group. It is noted that the grouping criteria of the “Outdated Mobile Devices copy” group is identical to the grouping criteria for the “Outdated Mobile Devices” group shown in FIG. 6. Cloning a group, such as for testing purposes, may be faster and more convenient than having to manually define a new group with identical grouping criteria as an existing group.

The GUI 700 further includes a “Delete” button 710 to delete the group and the associated grouping criteria and membership data. If a deleted group is used in a recursive group definition for another group, the other group may also be deleted. Alternatively, the user may be prompted regarding whether the other group should be deleted or whether the grouping criteria for the other group should be modified. The GUI 700 includes an “Edit” button 712 to edit the group (e.g., edit the name, e-mail notification status, and/or grouping criteria of the group).

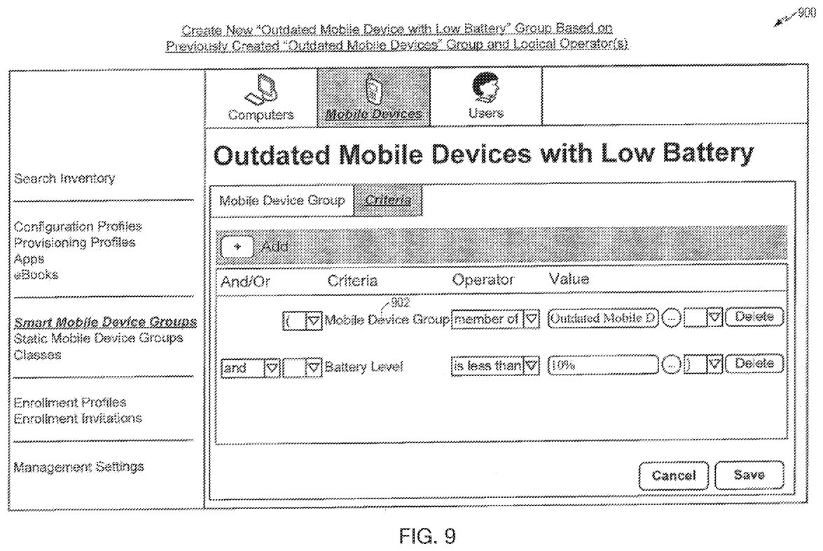

As described with reference to FIG. 1, the present disclosure enables users to recursively define dynamic groups based on membership in other dynamic groups. FIG. 9 illustrates a particular embodiment of a GUI used to define recursive grouping criteria and is generally designated 900. In the example of FIG. 9, grouping criteria for an “Outdated Mobile Device with Low Battery” dynamic group is defined. A mobile device is a member of the dynamic group if the mobile device is a member of the “Outdated Mobile Devices” group described with reference to FIG. 6 and if the mobile device has a battery level of less than 10%. As shown at 902, a “pseudo” inventory attribute called “Mobile Device Group” may be used to recursively define grouping criteria, where the value of the “Mobile Device Group” attribute is the name of another (e.g., previously defined) dynamic group. Corresponding “pseudo” inventory attributes for managed computers and managed users may be called “Computer Group” and “User Group,” respectively.

FIG. 9 thus illustrates an example of defining grouping criteria of a first dynamic group (e.g., the “Outdated Mobile Device with Low Battery” group) based on grouping criteria of a second dynamic group (e.g., the “Outdated Mobile Devices” group) and at least one logical operator (e.g., an AND operator). When membership of the second dynamic group changes, a MDM server (e.g., the MDM server 120 of FIG. 1) may automatically re-evaluate and update membership of the first dynamic group. The techniques of the present disclosure may thus enable definition of a dynamic group without re-entering grouping criteria from previously defined dynamic groups.

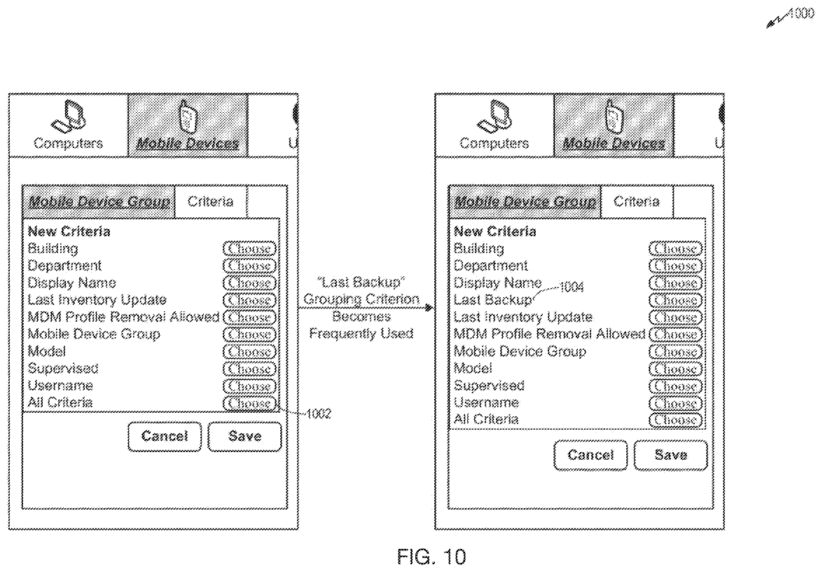

In a particular embodiment, a GUI generated in accordance with the described techniques may facilitate entry of grouping criteria by maintaining and displaying a list of frequently used grouping criteria (e.g., inventory data attributes). Referring to FIG. 10, a particular embodiment of maintaining such a “shortlist” is shown and generally designated 1000. When an inventory attribute is added to a grouping criteria (e.g., by selecting the button 602 of FIG. 6), the shortlist of frequently used inventory attributes may be shown instead of a list of all available inventory attributes. In the example on the left of FIG. 10, the shortlist includes: building, department, display name, last inventory update, MDM profile removal allowed, mobile device group, model, supervised, and username. An “All Criteria” option may also be shown, at 1002. Selection of the “All Criteria” option 1002 may display a complete list of all of the available inventory attributes that can be used to define grouping criteria. The shortlist and the complete list may differ based on whether grouping criteria is being defined for managed mobile devices, managed computers, or managed users.

The shortlist of frequently used attributes may be updated as users define dynamic groups. For example, as shown at 1004, after “Last Backup” is selected one or more times during definition of grouping criteria, the “Last Backup” attribute may be added to the shortlist. In a particular embodiment, the shortlist may have a fixed size, and an overflow condition may occur when adding an attribute to the list. In response to the overflow condition, when the attribute is added to the fixed size shortlist another (e.g., least recently used) attribute may be removed from the shortlist.

The GUI(s) generated in accordance with the present disclosure may also be used to indicate an action to be performed with respect to members of a dynamic group. Examples of MDM actions may include, but are not limited to, installing an application at a managed device, adjusting a configuration setting at a managed device, providing content to a managed device, sending a message to a managed device, setting or clearing a passcode, editing one or more inventory data attributes, sending a communication/message (e.g., an e-mail or a short message service (SMS) message), deleting data, sending remote commands, etc. Referring to FIG. 11, a particular embodiment of a GUI that can be used to select an action to be performed with respect to members of a dynamic group is shown and generally designated 1100. In an illustrative embodiment, the GUI 1100 may be after selection of the view button 706 of FIG. 7.

To illustrate, when the view button 706 is selected, a GUI may be displayed that includes a list of managed entities (e.g., computers, mobile devices, and/or users) that are members of a particular dynamic group. The list of managed entities may be based on the group membership data 128 of FIG. 1. In a particular embodiment, membership of the dynamic group may be re-evaluated (e.g., updated) when the user clicks the view button 706 of FIG. 7.

A user may select an element (e.g., button) on the GUI including the list of managed entities to cause the GUI 1100 to be displayed. The GUI 1100 may include a list of “mass actions” that can be performed with respect to each device that is a member of the dynamic group. In the example of FIG. 11, the list of actions includes editing a building or department of one or more managed entities of the group, editing a site of one or more managed entities of the group, sending a notification to one or more managed entities that have a particular application, content, or feature (e.g., self service mobile in FIG. 11) installed/activated, deleting one or more managed entities (e.g., from the group, the inventor database altogether, etc.), and sending remote command(s) to one or more managed entities. In alternative embodiments, different “mass actions” may be available. When an action is selected, the action may automatically be performed with respect to each managed entity of the group, or the user may be provided an option to select particular managed entities within the group as targets of the action.

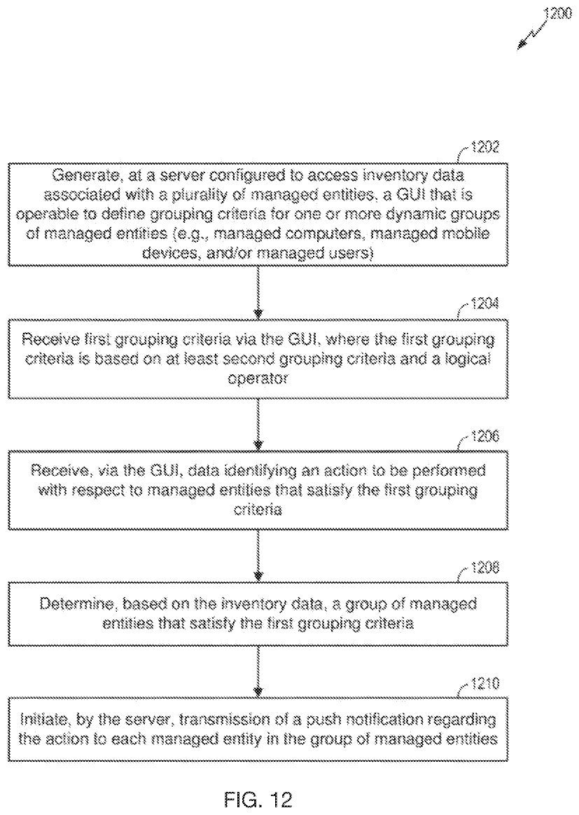

Referring to FIG. 12, a particular embodiment of operation at a MDM server is shown and generally designated 1200. In an illustrative embodiment, the method 1200 may be performed at the MDM server 120 of FIG. 1.

The method 1200 may include generating, at a server configured to access inventory data associated with a plurality of managed entities, a GUI that is operable to define grouping criteria for one or more dynamic groups of managed entities (e.g., managed computers, managed mobile devices, and/or managed users), at 1202. For example, to generate a dynamic grouping GUI, such as one of the GUIs described with reference to FIGS. 4-11, a MDM server may access inventory and/or group membership data and include in the GUI one or more elements (e.g., links, buttons, etc.) that are based on the inventory and/or group membership data. The MDM server may also enable and/or disable certain GUI elements based on the inventory and/or group membership data. For example, if no managed computers are registered with the MDM server, GUI elements relating to managed computers may be disabled (e.g., “grayed out” and/or unselectable by a user).

The method 1200 may also include receiving first grouping criteria via the GUI, at 1204, where the first grouping criteria is based on at least second grouping criteria and a logical operator. For example, the MDM server 120 may receive, via the GUI 900 of FIG. 9, the grouping criteria for the “Outdated Mobile Device with Low Battery” dynamic group, which is based on the grouping criteria for the “Outdated Mobile Devices” dynamic group and an AND operator. In a particular embodiment, the first grouping criteria may be received based on user input. For example, a MDM server may receive data via a wired or wireless network from a computing device that displays the GUI and receives the user input. The data may include a value typed by a user in a text field, an indication of a button selected by a user, etc. The MDM server may extract such data from received packets/messages and determine the first grouping criteria based on the extracted data.

The method 1200 may further include receiving data via the GUI that identifies an action to be performed with respect to managed entities that satisfy the grouping criteria, at 1206, and determining, based on the inventory data, a group of managed entities that satisfy the first grouping criteria, at 1208. The managed entities may include managed mobile devices, managed computers, managed users, or any combination thereof. In a particular embodiment, the data identifying the action may be received based on user input. For example, a MDM server may receive data via a wired or wireless network from a computing device that displays the GUI and receives the user input, where the data identifies an action selected by a user (e.g. from the GUI 1100 of FIG. 11). The MDM server may extract such data from received packets/messages and determine the selected action based on the extracted data. The MDM server may determine the group of managed entities that satisfy the first grouping criteria by filtering an inventory database using the first grouping criteria as filter parameters. Alternatively, or in addition, a list of members that may satisfy the first grouping criteria may be available in the form of group membership data, where the group membership data is updated in response to receiving updates from individual managed entities.

For example, as illustrated in FIG. 11, the MDM server may receive a selection of the “Send Remote Commands” action of FIG. 11 that is to be performed with respect to mobile devices in the “Outdated Mobile Devices with Low Battery” group.

The method 1200 may include initiating by the server a transmission of a push notification regarding the action that is sent to each managed entity in the group of managed entities, at 1210. For example, to initiate the transmission of the push notification, the MDM server may generate a push notification request that includes a list of group members and/or data regarding the action to be performed, and may send the push notification request to a push notification service (e.g., via a wired or wireless network). When communication to and from the MDM server is encrypted, receiving and transmitting data may also include encryption and/or decryption operations. To illustrate, in FIG. 1, the grouping criteria evaluation module 122 may identify members of the dynamic group and the MDM server 120 may send the notification request 124 to the push notification service 130. In response to the notification request 124, the push notification service 130 may send push notifications (e.g., the push notifications 131 and/or 132) to members of the dynamic group (e.g., the managed computer 140 and/or the managed mobile device 150).

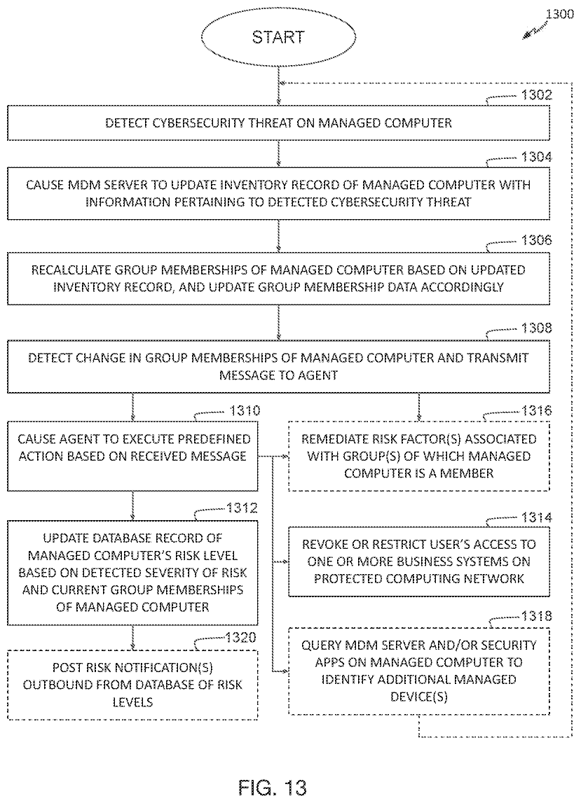

Referring to FIG. 13, a particular embodiment of operation at a managed computer 140 and a MDM server 120 in communication with each other is shown and generally designated 1300. In an illustrative embodiment, some operations of the method 1300 may be performed at the managed computer 140 and some operations of the method 1300 may be performed at the MDM server 120 of FIG. 1. The method 1300 may include bidirectional communications between the managed computer 140 and the MDM server 120 of FIG. 1. The method 1300 may provide dynamic reduction of attack surface and risk of lateral movement by cybersecurity threats in the event of a positive threat detection occurring on a user's managed computer 140. The managed computer 140 may include one or more apps or drivers installed thereon to provide additional risk signaling based on information provided by one or more applications 143 (e.g., security management apps) installed on the managed computer 140 and/or one or more applications 143 or 153 installed on the user's other managed computers 140 and/or managed mobile devices 150 (e.g., security tools or apps) which the user may have in use.

In an example, the MDM server 120 may have a device management app, such as but not limited to, JAMF PRO software installed and executing for management of one or more user endpoint devices, for example, the user's managed computer 140. The user's managed computer 140 may include an APPLE® MAC® laptop on which an endpoint computer security app such as, but not limited to, JAMF PROTECT software is installed and executing for providing endpoint security. The user's managed computer 140 may also have an endpoint security app such as, but not limited to, JAMF PRIVATE ACCESS software installed and executing to facilitate, enable, and secure network access by the user's managed computer 140 to various business systems via bidirectional communications with the MDM server 120. The user may authenticate to the business systems via an identity provider (IdP) that supports application programming interfaces (APIs) for user authentication (e.g., an IdP app such as, but not limited to, OKTA).

The method 1300 may include at 1302, detecting a cybersecurity threat on the user's managed computer 140. In an example, an endpoint computer security app such as, but not limited to, JAMF PROTECT executing on the user's APPLE® MAC® laptop may detect the cybersecurity threat.

The method 1300 may include at 1304, responsive to detecting the cybersecurity threat at 1302, causing the MDM server 120 to update the inventory record 212 in the inventory database 123 corresponding to the managed computer 140 with information reflecting the positive detection of the cybersecurity threat. In an example, an endpoint computer security app such as, but not limited to, JAMF PROTECT, responsive to detecting the cybersecurity threat at 1302, may trigger remediation integration among and/or between a device management app, such as but not limited to, JAMF PRO, and an endpoint computer security app such as, but not limited to, JAMF PROTECT, resulting in the inventory record 212 in the inventory database 123 corresponding to the managed computer 140 being updated with information reflecting the positive detection of the cybersecurity threat.

The method 1300 may include at 1306, responsive to the updating of the inventory record 212 in the inventory database 123, the grouping criteria evaluation module 122 of the MDM server 120 identifying the managed computer 140's updated security threat detection status from the inventory record 212, recalculating group memberships of the managed computer 140 based on the managed computer 140's updated security threat detection status, and updating the group membership data 128 based on the results of recalculating the group memberships. The updated group membership data 128 may reflect the managed computer 140 being added to a dynamic group and/or removed from a dynamic group based on detection of the cybersecurity threat on the user's managed computer 140. The updating of and the criteria for the group memberships may include identifying further risk(s) associated with the user's managed computer 140, for example, an outdated operating system (OS), a poor or problematic configuration, device geolocation, presence of virus or malware, outdated or unpatched software installed, or other characteristics relating to the hardware, software, location, or operation of the user's managed computer 140.

The method 1300 may include at 1308, the MDM server 120 detecting a change in the group memberships of the user's managed computer 140, and sending a message and/or control signal to an agent predetermined to receive notification of the change of group memberships, and/or an associated computing device. In an example, the agent may include computing instructions executable on a computing processor. In an example, the agent may include computing instructions executable on a computing processor together with the computing processor. In an example, the agent may include an electronic circuit, field programmable gate array (FPGA), application specific integrated circuit (ASIC), and/or other preconfigured electronic devices preconfigured to perform the predetermined functions of the agent. In an example, sending the message and/or control signal may include sending an HTML POST request (hereinafter, a “webhook”) to a defined URL predetermined to receive notification of the change of group memberships (hereinafter, a “webhook receiver”). The webhook may include or be an example of the message. The webhook receiver may include or be an example of the agent. The message may include information about the user's managed computer 140 stored in the associated inventory record 212 in the inventory database 123. In an example, computer-readable instructions executing on the MDM server 120 may include a messaging feature that detects the change in the group memberships of the user's managed computer 140 and triggers the output of the message to a defined agent. In an example, a device management app such as, but not limited to, JAMF PRO running on the MDM server 120 may include a messaging and/or webhook feature that detects the change in the group memberships of the user's APPLE MAC computer 140 and triggers the output message or webhook to the defined agent or webhook receiver.

The method 1300 may include at 1310, the agent, responsive to receiving the message at 1308, executing a predefined action. The predefined action may be implemented via computing instructions or a script executable on a computing processor, for example. The predefined action may include: (a) obtaining an API token for the MDM server 120 (e.g., a device management app, such as but not limited to, JAMF PRO running on the MDM server 120); (b) gathering information about the user's managed computer 140 from the received data of the message, and parsing the received data of the message to determine an ID code corresponding to the user's managed computer 140; and (c) querying the MDM server 120 (e.g., a device management app, such as but not limited to, JAMF PRO running on the MDM server 120 via an API of the app) to obtain the information about the user's managed computer 140 stored in the associated inventory record 212 in the inventory database 123, including the device identifiers of the user's managed computer 140 and the associated user's identifiers. The associated user's identifiers may be determined in conjunction with or with reference to an IdP app such as, but not limited to, OKTA, and/or a username associated with the user's computer system 140's associated inventory record 212 in the inventory database 123 of the MDM server 120 and/or a device management app, such as but not limited to, JAMF PRO running on the MDM server 120.

The method 1300 may include at 1312, capturing the user's managed computer 140's universally unique identifier (UUID) from the information about the user's managed computer 140 obtained from the associated inventory record 212 in the inventory database 123 at 1310. A database record of the user's managed computer 140's risk level may be updated based on a detected severity of risk and a current group membership of the user's managed computer 140. The risk level may be updated to one of several levels ranging from low, to medium, to high, for example. The UUID may be used to identify the user's managed computer 140 in the database record of the user's managed computer 140's risk level. In an example, the database record of the user's managed computer 140's risk level may be stored and/or accessed via a web interface and/or an API. In an example, the web interface and/or API may include an app such as, but not limited to, a JAMF RADAR web portal or other web portal app. In an example, the app may include an API feature such as, but not limited to, a JAMF RADAR API endpoint/risk/v1/override, which may promptly (e.g., immediately or nearly immediately) update the database record of the user's managed computer 140's risk level to trigger changes of access to protected systems in the protected computing network, e.g., through the user's managed computer 140's endpoint security apps (e.g., an endpoint security app such as, but not limited to, JAMF PRIVATE ACCESS). In an example, the operations of 1312 may be performed by the agent or associated computing device.

Updating the user's managed computer 140's risk level in the database record of the user's managed computer 140's risk level (e.g., but not limited to, the web portal app, the JAMF RADAR web portal, and/or other database) may include a risk signaling based on cybersecurity threat detection, enriched by computer inventory and configuration details (e.g., inventory database 123) from the MDM server 120, facilitating the user's managed computer 140 to be recategorized within the database record of the user's managed computer 140's risk level (e.g., but not limited to, the web portal app, the JAMF RADAR web portal, and/or other database) and/or any security and access policies within the user's managed computer 140's security apps (e.g., a security app such as, but not limited to, JAMF PRIVATE ACCESS) correspondingly adjusted for the user's managed computer 140. For example, an updated risk posture for the user's managed computer 140 that is moderate or medium risk may limit or restrict the user's managed computer 140's access to business computing systems and resources, e.g., customer relationship management (CRM) and human resources (HR) systems, while still permitting the user's managed computer 140 to access business computing systems considered less critical. If the updated risk posture for the user's managed computer 140 is high, the user's managed computer 140 may be restricted from accessing all computing systems on the organization's protected computing network. Risk may thus be mitigated across any business or computing system in the protected computing networking environment for whom access is gated by managed devices' endpoint security apps (e.g., a security app such as, but not limited to, JAMF PRIVATE ACCESS).

The method 1300 may include at 1314, responsive to obtaining the user's identifiers at 1310 (e.g., determined in conjunction with or with reference to an IdP app such as, but not limited to, OKTA, and/or a username associated with the user's computer system 140's associated inventory record 212 in the inventory database 123 of the MDM server 120 and/or a device management app, such as but not limited to, JAMF PRO running on the MDM server 120), restricting and/or revoking the user's access to one or more business systems on the computing network protected by the MDM server 120 and/or a device management app, such as but not limited to, JAMF PRO running on the MDM server 120, and/or the computing network or one or more portions thereof itself. First, the IdP (e.g., an IdP app such as, but not limited to, OKTA) API may be queried with the user's identifiers (e.g., username) to obtain the user ID from the IdP (which may be dependent upon what IdP features and IdP API capabilities are provided). Second, the IdP's API may be queried to disable the user account associated with the user ID inside the IdP, thereby preventing the user account from being used for new authentications to any business system on the organization's protected computing network using the IdP for authentication and/or authorization. In an example, the user's IdP username may be associated to the computer inventory record inside a device management app, such as but not limited to, JAMF PRO running on the MDM server 120, via an Extension Attribute feature if populating from an authentication or identity management app such as, but not limited to, JAMF CONNECT during inventory collection or if populating from native user information collection during inventory collection. Any active sessions for the disabled user accounts may also be invalidated. In certain other aspects, the IdP's API may be queried to clear user session tokens (API token), force a password reset, suspend user, and other appropriate actions.

The above operations at 1312 and 1314 to restrict the user's computer system 140's access to the organization's systems on the protected computer network (e.g., at 1312) and restricting or disabling the user's user account(s) on the organization's systems on the protected computer network (e.g., at 1314) may be designed to mitigate risk and reduce access of a moderate to high risk computer system 140 and associated user to business critical systems on the organization's protected computer network.

The method 1300 may optionally include at 1316, responsive to information obtained at 1310 and/or group membership data 128 corresponding to the user's managed computer 140 (a change in which may be detected at 1308), execution of one or more operations to remediate one or more risk factors associated with one or more groups of which the user's managed computer 140 is a member. The remediation of risk factors associated with group membership may be targeted to resolve one or more risks that cause the user's managed computer 140 to be included as a member of the group associated with the one or more risks. By resolving the one or more risks, the user's managed computer 140 may be returned to a membership status in one or more groups that are not associated with the one or more risk factors and may no longer be a member of the one or more groups that are associated with the one or more risk factors, such that the user and/or the user's managed computer 140 may resume normal access to services of the organization's protected computing network. Resolving the risks may include patching some software application that presents a risk because of a need to be patched, changing a configuration of a software application, operating system, or hardware that presents a risk due to a current configuration, for example, to bring the user's managed computer 140 back into a manageable and acceptable risk level.

The method 1300 may optionally include at 1318, responsive to obtaining the user's identifiers at 1310 (e.g., determined in conjunction with or with reference to an IdP app such as, but not limited to, OKTA, and/or a username associated with the user's computer system 140's associated inventory record 212 in the inventory database 123 of the MDM server 120 and/or a device management app, such as but not limited to, JAMF PRO running on the MDM server 120), querying the MDM server 120 and/or one or more security applications 143 installed on the user's managed computer 140 to identify one or more additional managed devices (e.g., managed computers 140 and/or managed mobile devices 150) associated with the user having the username and/or other obtained user's identifiers. For each of one or more additional managed devices that may be identified as being associated with the user, operations of the method 1300 may be performed to establish additional risk signaling and access restrictions in a corresponding manner and having a corresponding effect as the risk signaling and access restrictions established for the user's managed computer 140 as described above. Thus, group membership and/or restrictions established based on one user's managed computer 140 may be applied to all managed devices on the managed computing network associated with the user.

The method 1300 may optionally include at 1320, responsive to updating at 1312 the user's managed computer 140's risk level in the database record of the user's managed computer 140's risk level (e.g., a web portal such as, but not limited to, the JAMF RADAR web portal), posting one or more risk notifications outbound from the database of risk levels (e.g., a web portal such as, but not limited to, the JAMF RADAR web portal), in an industry-standard format (e.g., CAPE/SDP) to inform other security tools and apps operating within the protected computing network environment.

The methods and operations described herein facilitate providing cybersecurity capabilities using a networked device management solution as a middle-man. Benefits include layering on additional cybersecurity risk context regarding the user's managed computer 140 (e.g., an APPLE MAC computer) from a wide array of computer characteristic and configuration inventory data (e.g., stored in the inventory database 123). Such inventory data may range from simple or straightforward information, for example, out of date operation system (OS) versions to complex information, for example, device geolocation or specific configuration settings by grouping managed devices in the protected network according to computer characteristic and configuration inventory data associated with different risk factors and/or risk levels. The methods and operations described herein facilitate securing and protecting both cloud-based and on-premises computing networks (e.g., via security software such as, but not limited to, JAMF PRIVATE ACCESS software solutions), risk signaling as described herein may provide broad risk mitigation of lateral movement across any business critical computing system in the protected computer networking environment. Benefits also include layering on additional risk context such as state and context from additional managed devices in the protected computing network owned or controlled by the user who owns or controls the managed computer 140 discussed above.

It should be noted that the order of steps or operations described with reference to FIGS. 1-13 is to be considered illustrative and not limiting. In alternative embodiments, the order of steps may be different. Further, one or more steps may be optional and/or replaced by other steps. For example, in particular embodiments the steps 1202 and 1204 may be optional (e.g., a dynamic group may previously have been defined and the method 1200 may begin at step 1206 when a user selects an action to be performed with respect to members of the dynamic group). In addition, one or more steps may be consolidated. In accordance with various embodiments of the present disclosure, one or more methods, functions, and modules described herein may be implemented by software programs executable by a computer system. Further, implementations of one or more embodiments in accordance with the present disclosure can include distributed processing, component/object distributed processing, and/or parallel processing.

Particular embodiments can be implemented using a computer system executing a set of instructions that cause the computer system to perform any one or more of the methods or computer-based functions disclosed herein. A computer system may include a laptop computer, a desktop computer, a server computer, a mobile phone, a tablet computer, a media player, one or more other computing devices, or any combination thereof. The computer system may be connected, e.g., using a network, to other computer systems or peripheral devices. For example, the computer system or components thereof can include or be included within any one or more of the MDM server 120 of FIG. 1, a computing device or server corresponding to the push notification service 130 of FIG. 1, the managed computer 140 of FIG. 1, the managed mobile device 150 of FIG. 1, the e-mail server 170 of FIG. 1, an output device that displays a GUI generated by an MDM server, an input device that receives user input responsive to the GUI, and/or a computing device that includes the output device and the input device.

In a networked deployment, the computer system may operate in the capacity of a server or as a client user computer in a server-client user network environment. The term “system” can include any collection of systems or sub-systems that individually or jointly execute a set, or multiple sets, of instructions to perform one or more computer functions.

In a particular embodiment, the instructions can be embodied in a computer-readable or a processor-readable device. The terms “computer-readable device” and “processor-readable device” include a single storage device or multiple storage devices, such as a centralized or distributed memory, and/or associated caches and servers that store one or more sets of instructions. The terms “computer-readable device” and “processor-readable device” also include any device that is capable of storing a set of instructions for execution by a processor or that cause a computer system to perform any one or more of the methods or operations disclosed herein. For example, a computer-readable or processor-readable device or storage device may include random access memory (RAM), flash memory, read-only memory (ROM), programmable read-only memory (PROM), erasable programmable read-only memory (EPROM), electrically erasable programmable read-only memory (EEPROM), registers, a hard disk, a removable disk, a disc-based memory (e.g., compact disc read-only memory (CD-ROM)), a solid-state memory, or any other form of storage device. A computer-readable or processor-readable device is not a signal.

In a particular embodiment, a method includes generating, at a server configured to access inventory data associated with one or more managed devices, a GUI that is operable to define grouping criteria for one or more dynamic groups of managed devices. The method also includes receiving, at the server via the GUI, first grouping criteria and data identifying an action to be performed with respect to managed devices that satisfy the first grouping criteria. The first grouping criteria is based on at least second grouping criteria and a logical operator. The method further includes determining, at the server based on the inventory data, a group of managed devices that satisfy the first grouping criteria. The method includes initiating, by the server, transmission of a push notification regarding the action to each managed device in the group of managed devices.

In another particular embodiment, an apparatus includes a processor and a memory storing instructions that, when executed by the processor, cause the processor to perform operations including generating a GUI that is operable to define grouping criteria for one or more dynamic groups of managed devices. The operations also include receiving first grouping criteria via the GUI, where the first grouping criteria is based on at least second grouping criteria and a logical operator. The operations further include receiving, via the GUI, data identifying an action to be performed with respect to managed devices that satisfy the first grouping criteria. The operations further include determining, based on inventory data, a group of managed devices that satisfy the first grouping criteria, and initiating transmission of a push notification regarding the action to each managed device in the group of managed devices.

In another particular embodiment, a computer-readable storage device stores instructions that, when executed by a processor, cause the processor to perform operations including generating, at a server configured to access inventory data associated with one or more managed devices and one or more managed users, a GUI that is operable to define grouping criteria for one or more groups of managed devices, managed users, or both. The operations also include receiving, at the server, first grouping criteria via the GUI and receiving, at the server via the GUI, data identifying an action to be performed with respect to managed devices that satisfy the first grouping criteria. The first grouping criteria is based on at least second grouping criteria and a logical operator. The operations further include determining, at the server based on the inventory data, a group of managed devices, a group of managed users, or both that satisfy the first grouping criteria. The operations include initiating, by the server, transmission of a push notification regarding the action to each managed device in the group of managed devices, to at least one device associated with each user in the group of managed users, or both.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What we claim is:

1. A method comprising:
identifying an elevated risk factor of an endpoint device on a computing network according to one or more characteristics of the endpoint device;
including the endpoint device having the elevated risk factor in a group of endpoint devices identified as having an elevated risk level; and
restricting access by the group of endpoint devices identified as having the elevated risk level to one or more computing systems and/or computing applications accessible on the computing network based on the elevated risk level.

2. The method of claim 1, wherein the one or more characteristics of the endpoint device includes a version of an installed operating system being out of date.

3. The method of claim 1, wherein the one or more characteristics of the endpoint device includes a geolocation of the endpoint device.

4. The method of claim 1, further comprising:
identifying a user associated with the endpoint device having the elevated risk factor;
identifying one or more additional endpoint devices on the computing network associated with the identified user; and
including the one or more additional endpoint devices in the group of endpoint devices identified as having the elevated risk level.

5. The method of claim 4, further comprising:
disabling user credentials associated with the user on one or more computing systems and/or computing applications accessible on the computing network based on the elevated risk factor.

6. The method of claim 5, further comprising:
remediating the elevated risk factor associated with the group of endpoint devices.

7. The method of claim 6, further comprising:
returning, in response to remediating the elevated risk factor, the endpoint device to a membership status.

8. An apparatus comprising:
a processor; and
a memory configured to store instructions that, when executed by the processor, cause the processor to:
identify an elevated risk factor of an endpoint device on a computing network according to one or more characteristics of the endpoint device;
include the endpoint device having the elevated risk factor in a group of endpoint devices identified as having an elevated risk level; and
restrict access by the group of endpoint devices identified as having the elevated risk level to one or more computing systems and/or computing applications accessible on the computing network based on the elevated risk level.

9. The apparatus of claim 8, wherein the one or more characteristics of the endpoint device includes a version of an installed operating system being out of date.

10. The apparatus of claim 8, wherein the one or more characteristics of the endpoint device includes a geolocation of the endpoint device.

11. The apparatus of claim 8, wherein the memory is configured to store instructions that, when executed by the processor, cause the processor to:
identify a user associated with the endpoint device having the elevated risk factor;
identify one or more additional endpoint devices on the computing network associated with the identified user; and
include the one or more additional endpoint devices in the group of endpoint devices identified as having the elevated risk level.

12. The apparatus of claim 11, wherein the memory is configured to store instructions that, when executed by the processor, cause the processor to:
disable user credentials associated with the user on one or more computing systems and/or computing applications accessible on the computing network based on the elevated risk factor.

13. The apparatus of claim 12, wherein the memory is configured to store instructions that, when executed by the processor, cause the processor to:
remediate the elevated risk factor associated with the group of endpoint devices.

14. The apparatus of claim 13, wherein the memory is configured to store instructions that, when executed by the processor, cause the processor to:
return, in response to remediating the elevated risk factor, the endpoint device to a membership status.

15. A non-transitory computer-readable storage device storing instructions that, when executed by a processor, cause the processor to:
identify an elevated risk factor of an endpoint device on a computing network according to one or more characteristics of the endpoint device;
include the endpoint device having the elevated risk factor in a group of endpoint devices identified as having an elevated risk level; and
restrict access by the group of endpoint devices identified as having the elevated risk level to one or more computing systems and/or computing applications accessible on the computing network based on the elevated risk level.

16. The non-transitory computer-readable storage device of claim 15, wherein the one or more characteristics of the endpoint device includes a version of an installed operating system being out of date.

17. The non-transitory computer-readable storage device of claim 15, wherein the one or more characteristics of the endpoint device includes a geolocation of the endpoint device.

18. The non-transitory computer-readable storage device of claim 15, further storing instructions that, when executed by a processor, cause the processor to:
identify a user associated with the endpoint device having the elevated risk factor;
identify one or more additional endpoint devices on the computing network associated with the identified user; and
include the one or more additional endpoint devices in the group of endpoint devices identified as having the elevated risk level.

19. The non-transitory computer-readable storage device of claim 18, further storing instructions that, when executed by a processor, cause the processor to:
disable user credentials associated with the user on one or more computing systems and/or computing applications accessible on the computing network based on the elevated risk factor.

20. The non-transitory computer-readable storage device of claim 19, further storing instructions that, when executed by a processor, cause the processor to:
remediate the elevated risk factor associated with the group of endpoint devices.
